(19) United States
(12) Patent Application Publication
(10) Pub. No.: US 2025/0039310 A1
(43) Pub. Date: Jan. 30, 2025

(54) IMAGE PROCESSING SYSTEM, IMAGE PROCESSING DEVICE, AND NON-TRANSITORY COMPUTER-READABLE STORAGE MEDIUM THEREFOR

(71) Applicant: BROTHER KOGYO KABUSHIKI KAISHA, Nagoya (JP)

(72) Inventors: Taiga MIZUMORI, Nagoya (JP); Daisuke MATSUMOTO, Nagoya (JP); Thanh NGUYENVAN, Nagoya (JP); Toshikazu HORI, Nagoya (JP); Toshiki MOTOYAMA, Konan (JP); Satoshi MATSUSHITA, Nagoya (JP); Hiroya NOJIRI, Nagoya (JP); Satoru YANAGI, Obu (JP); Tomomi SHIRAKI, Nagoya (JP); Akihito UNO, Iwakura (JP)

(21) Appl. No.: 18/784,178

(22) Filed: Jul. 25, 2024

(30) Foreign Application Priority Data
Jul. 28, 2023 (JP) 2023-123774

(51) Int. Cl. H04N 1/00; H04N 1/32

(52) U.S. Cl. CPC H04N 1/0023; H04N 1/32128

(57) ABSTRACT

Provided is an image processing system including an image processing device and a computer. The image processing device and the computer are connected to a network. The computer has capability of performing data communication using a first communication or a second communication different from the first communication. The image processing device is configured to perform data communication in accordance with at least the first communication. The computer includes a controller configured to retrieve capability information stored in a capability information repository of the image processing device and determine whether the capability information includes second communication implementation information. When the capability information includes the second communication implementation information, the controller designates a port to perform the second communication and perform data communication using the second communication, and when the capability information does not include the second communication implementation information, the controller does not designate the port to perform the second communication.

### REFERENCE TO RELATED APPLICATIONS

This application claims priority from Japanese Patent Application No. 2023-123774 filed on Jul. 28, 2023. The entire content of the priority application is incorporated herein by reference.

### BACKGROUND ART

The present disclosure relates to an image processing system, an image processing device, and a non-transitory computer-readable recording medium therefor.

There has been known an image processing system in which a PC (Personal Computer), which is an example of a computer, and an MFP (Multi-Function Peripheral), which is an example of an image processing device, are connected to a network such as the Internet or a LAN (Local Area Network). In such an environment (i.e., a system configuration), it is possible to perform a pull-scan, in which the PC transmits an instruction requesting scan data to the MFP, and the MFP transmits the scan data of an object to be read, which is set in the MFP, to the PC in response to the request.

### DESCRIPTION

To ensure confidentiality of the pull-scan, an encrypted communication, which is a data communication using encrypted data, is effective. In order to perform the encrypted communication between the PC and the MFP, both the PC and the MFP must have a program for the encrypted communication that is different from a program for unencrypted communication. Therefore, when the encrypted data communication to the MFP is initiated by the PC, but the MFP does not have a program for the encrypted communication installed, the encrypted data communication between the PC and the MFP cannot be continued and a communication error occurs.

Such problems may occur not only in a combination of the encrypted communication and the unencrypted communication but also, in general, in a combination of a first communication implemented by a first program and a second communication implemented by a second program that is different from the first program, such as a communication that uses different communication speeds, different data compression schemes, or the like.

According to aspects of the present disclosure, there is provided an image processing system including an image processing device and a computer, the image processing device and the computer being connected to a network. The computer has capability of performing data communication in accordance with a first communication and in accordance with a second communication that is different from the first communication. The image processing device is configured to perform data communication in accordance with at least the first communication. The image processing device includes an image processing engine configured to perform image processing, and a capability information repository configured to store capability information indicating capabilities of the image processing device. The computer includes a controller configured to retrieve the capability information stored in the capability information repository of the image processing device, determining whether the capability information includes second communication implementation information indicating that the image processing device is capable of performing the second communication. When the capability information includes the second communication implementation information, the controller designates a port to perform the second communication and performs data communication for the image processing in accordance with the second communication, and when the capability information does not include the second communication implementation information, the controller does not designate the port to perform the second communication.

According to aspects of the present disclosure, there is provided a non-transitory computer-readable recording medium for a computer which is configured to be connected to an image processing device through a network, the image processing device having an image processing engine to perform image processing and a capability information repository storing capability information concerning capabilities of the image processing device, the recording medium storing computer-executable instructions that cause, when executed, the computer to perform retrieving the capability information stored in the capability information repository of the image processing device, determining whether the capability information includes second communication implementation information indicating that the image processing device is capable of performing a second communication which is different from a first communication, when the capability information includes the second communication implementation information, designating a port to perform the second communication and causing the image processing device to perform data communication for the image processing in accordance with the second communication, and when the capability information does not include the second communication implementation information, not designating a port to perform the second communication.

An image processing device including a first communication port for a first communication to be implemented by a first program such that the image processing device is connectable to a computer through a network, a second communication port for a second communication to be implemented by a second program such that the image processing device is connectable to the computer through the network. The second program is different from the first program. The image processing device further includes an image processing engine configured to perform image processing, and a capability information repository configured to store capability information concerning capabilities the image processing device has. The capability information contains second communication implementation information indicating that the image processing device has a capability of the second communication.

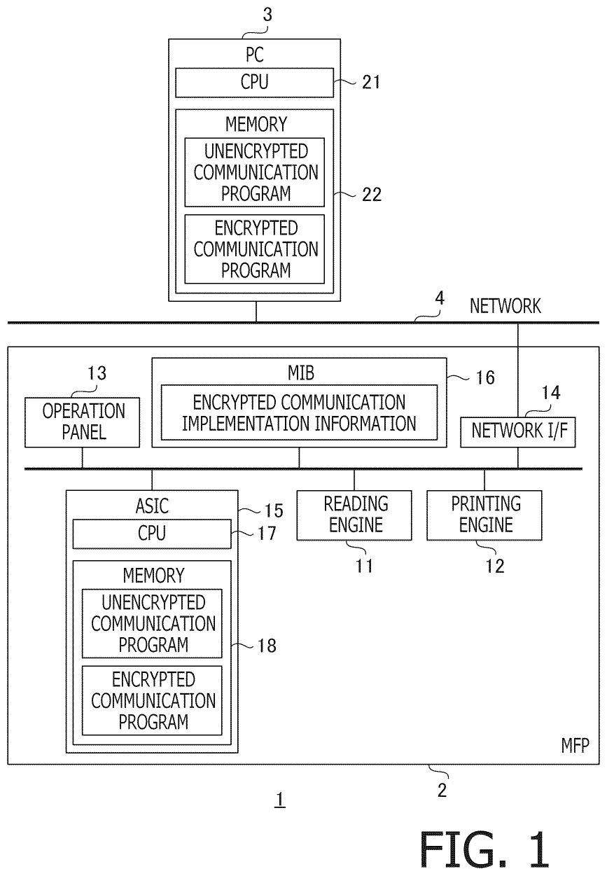

FIG. 1 is a block diagram schematically illustrating a configuration of an image processing system.

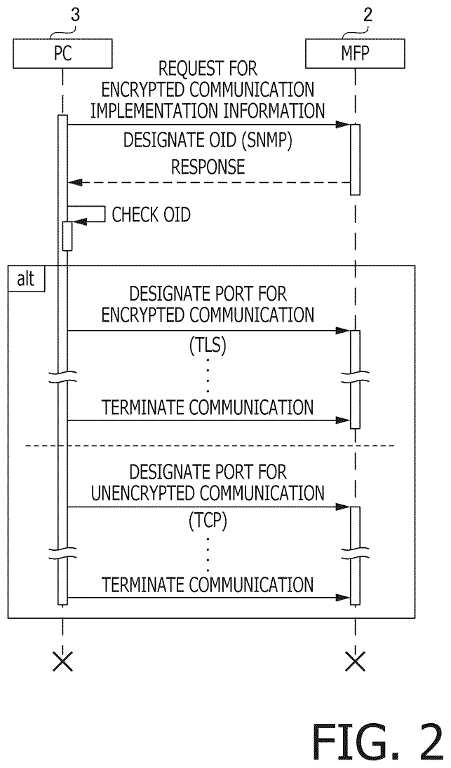

FIG. 2 is a sequence diagram showing a flow of data when a pull-scan is performed.

Hereinafter, an embodiment according to the present disclosure will be described with reference to the accompanying drawings.

FIG. 1 shows an image processing system 1. The image processing system 1 includes an MFP (Multi-Function Peripheral) 2, which is an example of an image processing device, and a PC (Personal Computer) 3, which is an example of a computer. The image processing system 1 is configured such that the MFP 2, the PC 3, and other devices (if any) are connected to a network 4. The network 4 includes one or both of the Internet and a local area network (LAN).

The MFP 2 has multiple image processing functions. The multiple image processing functions include an image reading function and a printing function. The image reading function is a function of optically reading an object to be read (hereinafter referred to as a “target object”) to generate image data of the target object. The printing function is a function of printing an image represented by image data on a sheet of printing paper or other sheets. The MFP 2 includes a reading engine 11 configured to perform the image reading function and a printing engine 12 configured to perform the printing function.

The reading engine 11, which is an example of an image processing device, performs the reading function by performing an image reading process. The reading engine 11 may be configured with a method using a CIS (contact image sensor) system as the image reading method. In this configuration, a reading device having a light source and an image sensor is provided in the reading engine 11. The image sensor has a plurality of light receiving elements arranged at an equal pitch in the main scanning direction. When light from a light source is reflected by the target object and the reflected light enters the image sensor, photoelectric conversion is performed at each light receiving element, and a voltage (an electric signal) corresponding to the received amount of light is output from each light receiving element. In this way, reading of a line in the main scanning direction of the target object is achieved. In the reading process, the reading device reads the target object line by line, while the reading device and the target object are moved relative to each other in a sub-scanning direction that is orthogonal to the main scanning direction.

The reading engine 11 is not necessarily limited to a configuration using the CIS system, which is an equal magnification optical system, but may also be a configuration using a reduction optical system, e.g., a CCD (Charge Coupled Devices) system.

The printing engine 12 achieves the printing function by performing the printing process. The printing engine 12 may be configured with an inkjet printing system. In such a configuration, the printing engine 12 is provided with a print head having a plurality of nozzles. In the printing process, ink droplets are selectively ejected from the nozzles of the print head while the sheet is being conveyed, and when the ink droplets are ejected onto the sheet, an image formed by dots created by the ink droplets is printed on the sheet.

The printing engine 12 is not necessarily limited to a configuration using an inkjet printing method, but may also be a configuration using an electrophotographic method or a thermal method.

The MFP 2 has an operation panel 13 and a network interface 14.

The operation panel 13 is a human interface and includes, for example, a touch panel with pressure-sensitive or capacitive transparent film switches overlaid on a liquid crystal display. The touch panel displays various types of information, including keys to be operated for various settings and contents set by such key operations. In addition to the touch panel, the operation panel 13 may be equipped with physical keys, e.g., keys of a numeric keypad to be used for various settings.

The network interface 14 is a piece of hardware that contains communication circuits and other components necessary to communicate with external devices such as the PC 3 via the network 4.

In addition, the MFP 2 has an ASIC (Application Specific Integrated Circuit) 15 and an MIB (Management Information Base) 16.

The ASIC 15, which is an example of an image processing device, includes a CPU 17 and a memory 18. The memory 18 includes a non-volatile memory, such as flash memory and EEPROM (Electrically Erasable Programmable ROM), and a volatile memory, such as a DRAM (Dynamic Random Access Memory). The non-volatile memory stores programs for various processes. The CPU 17 is configured to execute programs stored in the non-volatile memory of the memory 18 and to use the volatile memory of the memory 18 as a work area during the execution of the programs.

The ASIC 15 is further provided with an A/D conversion circuit. The A/D conversion circuit has a resolution of, for example, 8 bits (0-255 steps) and performs A/D conversion of electrical signals (voltage value signals) output from the reading device of the reading engine 11 into digital image data (pixel value data). In the A/D conversion process, for example, the voltage below a lower limit reference voltage (lower limit value) is uniformly converted into pixel data “0”, the voltage above an upper limit reference voltage (upper limit value) is uniformly converted into pixel data “255”, and the voltage between the lower limit value and the upper limit value is converted into pixel data according to the magnitude of the voltage. Since the target object is read by the reading device line by line, and the electrical signals output from the reading device at each line read are converted into image data, the reading process is completed.

The MIB 16 (an example of a capability information repository) is a text file that describes information available in SNMP (Simple Network Management Protocol) in a tree structure, and includes an extended MIB that allows a manufacturer of the MFP 2 to store information set independently for the MFP 2. The network 4 enables communication using TCP/IP (Transmission Control Protocol/Internet Protocol), and SNMP is an application layer protocol that is used when monitoring and controlling devices having communication functions (e.g., the MFP 2) from the PC 3 or the like. The MIB 16 stores capability information, which is information about various capabilities of the MFP 2 as originally set by the manufacturer of the MFP 2. To each piece of information stored in the MIB 16, a unique object identifier (OID) is assigned.

The PC 3 has a CPU 21 and a memory 22. The memory 22 includes a non-volatile memory, such as a flash memory or an EEPROM, and a volatile memory, such as a DRAM (Dynamic Random Access Memory). The non-volatile memory stores programs for various processes. The CPU 21 is configured to execute the programs stored in the non-volatile memory of the memory 22, while using the volatile memory of the memory 22 as a work area during the execution of the programs.

The image processing system 1 is configured to perform a pull-scan in which the PC 3 transmits an instruction to cause the MFP 2 to transmit image data of the target object from the MFP 2 to the PC 3. When the PC 3 instructs the MFP 2 to perform the pull-scan, data communication is performed between the MFP 2 and the PC 3 in response to the instruction, in order to perform the pull-scan process, which is an example of image processing performed by the MFP 2.

In the PC 3, an unencrypted communication program for the unencrypted communication and an encrypted communication program for the encrypted communication are implemented. In addition, an unencrypted communication program is implemented in the MFP 2 for unencrypted communication. However, for encrypted communication, an encrypted communication program may or may not be implemented depending on the MFP 2. According to the above configuration, the image processing system 1 can perform data communication for performing the pull-scan process using the unencrypted communication or, if the encrypted communication program is implemented in the MFP 2, using the encrypted communication.

Note that when the MFP 2 is implemented with the encrypted communication program and is capable of performing encrypted communication, the capability information stored in the MIB 16 of the MFP 2 includes encrypted communication implementation information indicating that the MFP 2 has a function to perform encrypted communication.

Before starting the data communication to perform the pull-scan process, the PC 3 refers to the capability information stored in the MIB 16 of the MFP 2 and checks whether the capability information includes the encrypted communication implementation information. If the capability information includes the encrypted communication implementation information, it is confirmed the MFP 2 has the encrypted communication program installed and is capable of performing the encrypted communication. If the capability information does not include the encrypted communication implementation information, it is confirmed the MFP 2 does not have the encrypted communication program installed. In such a case, the unencrypted communication is used between the PC 3 and the MFP 2.

In the following description, it is assumed that the MFP 2 is capable of performing the encrypted communication, that is, the capability information stored in the MIB 16 of the MFP 2 includes the encrypted communication implementation information.

When the user operates the PC 3 to input a pull-scan start command, the CPU 21 of the PC 3 executes a TCP/IP stack with the SNMP as an application-layer protocol, and as shown in FIG. 2, a request designating an object identifier (OID) of the encrypted communication implementation information stored in the MIB 16 is transmitted (hereinafter, an operational command for transmitting such a request will be referred to as “GetRequest” command) from the PC3 to the MFP 2. In response to the request above, a value of the OID that is designated by the PC 3 is transmitted (hereinafter, an operational command to obtain a value in response to the above request will be referred to as “GetResponse”) from the MFP 2 to the PC 3.

When the PC 3 receives the response from the MFP 2, the CPU 21 of the PC 3 checks whether the capability information stored in the MIB 16 contains the encrypted communication implementation information based on the value of the OID received from the MFP 2.

When it is confirmed that the capability information stored in MIB 16 contains the encrypted communication implementation information, that is, when it is confirmed that the MFP 2 has the capability to perform the encrypted communication, the CPU 21 of the PC 3 implements a TCP/IP stack (i.e., the encrypted communication program) that uses TLS (Transport Layer Security) between the application layer protocol that performs the pull-scan process and TCP, which is a transport layer protocol. In this way, a port for the encrypted communication port corresponding to the encrypted communication program, in other words, a port for the encrypted communication is designated from the PC 3 to the MFP 2, and the data communication for performing the pull-scan process is started. Then, the data communication for performing the pull-scan process is started between the PC 3 and the MFP 2 using the encrypted communication. Various settings such as reading resolution for the pull-scan process are made on the PC 3, and the MFP 2 performs the pull-scan process according to the settings (i.e., the reading resolution, etc.) made on the PC 3.

When an MFP different from the MFP 2 (hereinafter referred to as “the other MFP”) is connected to the network 4, and if capability information stored in an MIB of the other MFP does not contain the encrypted communication implementation information (e.g., when the other MFP does not have an encrypted communication program installed), the CPU 21 of the PC 3 confirms that the capability information stored in the MIB of the other MFP does not contain the encrypted communication implementation information based on the value of the OID received from the other MFP.

When it is confirmed that the capability information stored in the MIB of the other MFP does not contain the encrypted communication implementation information, a TCP/IP stack without TLS (i.e., the unencrypted communication program) is executed between the application layer protocol that performs the pull-scan process and TCP, i.e., the transport layer protocol. Then, the port for the unencrypted communication corresponding to the unencrypted communication program, in other words, the port for the unencrypted communication is designated from the PC 3 to the MFP 2, and the data communication for performing the pull-scan process is started between the PC 3 and the MFP 2. In the MFP 2, the pull-scan process according to the settings input through the PC 3 is performed. In the pull-scan process, the image reading process by the reading engine 11 is performed, thereby image data of the target object being generated, and the generated image data is transmitted from the MFP 2 to the PC 3 without being encrypted (i.e., using the unencrypted communication).

As described above, the PC 3 accesses the MIB 16 of the MFP 2 to check whether the capability information stored in the MIB 16 contains the encrypted communication implementation information. When the PC 3 confirms that the capability information stored in the MIB 16 includes the encrypted communication implementation information, the port for the encrypted communication is designated and the data communication for performing the pull-scan process is performed using the encrypted communication.

In this way, it is possible to prevent the PC 3 from initiating the encrypted communication when the MFP 2 is not configured to perform the encrypted communication. As a result, when the MFP 2 does not have the capability to perform the encrypted communication, occurrence of communication errors due to the encrypted communication can be prevented.

While aspects of the present disclosure have been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

In the embodiment described above, the data communication for performing the pull-scan process (including the transmission of the image data of the target object) is switched between the encrypted communication, which is an example of a first communication, and the unencrypted communication, which is an example of a second communication, depending on whether the MPF is capable of performing the second communication or not.

It is noted, however, the combination of the first communication and the second communication according to aspects of the present disclosure is not necessarily limited to the combination of the encrypted communication and the unencrypted communication. That is, the combination of the first and second communications according to aspects of the present disclosure may be, for example, a combination of a high-compression communication in which data communication is performed with data compressed at a relatively high compression ratio and a low-compression communication in which data communication is performed with data compressed at a relatively low compression ratio. If the compression method differs between the high-compression and low-compression communications, the program for the high-compression communication differs from the program for the low-compression communication.

For example, if the MIB 16 of the MFP 2 stores high-compression communication implementation information indicating that the MFP 2 has a high-compression communication capability, and if it is confirmed by the PC 3 that the capability information stored in the MIB 16 includes the high-compression communication implementation information, a port for the high-compression communication may be designated and the data communication for performing the pull-scan process is performed using the high-compression communication. On the other hand, if it is confirmed by the PC 3 that the capability information stored in the MIB 16 does not contain the high-compression communication implementation information, a port for the low-compression communication may be designated and the data communication for performing the pull-scan process may be performed using the low-compression communication.

In the embodiment described above, the image processing system 1 is capable of performing the pull-scan. Alternatively or optionally, the image processing system may be configured to perform a push-scan, in which the MFP 2 transmits image data of a target object to the PC 3 in response to an operation on the operation panel 13 of the MFP 2. In this case, various settings such as reading resolution in the push-scan are made by operating the operation panel 13.

If the image processing system 1 is configured to perform the push-scan and the start of the push-scan is instructed, then the MFP 2 notifies the PC 3 that the start of the push-scan has been instructed. Upon receipt of this notification, the PC 3 transmits (GetRequest) a request to the MFP 2 designating the OID of the encrypted communication implementation information stored in the MIB 16. In response to the request, the value of the OID designated by the PC 3 is transmitted from the MFP 2 to the PC 3 (GetResponse).

If it is confirmed that the capability information stored in the MIB 16 includes the encrypted communication implementation information, information on a port for encrypted communication is transmitted from the PC 3 to the MFP 2, and the data communication is initiated between the PC 3 and the MFP 2 for performing the push-scan process, which is an example of image processing. In the MFP 2, the push-scan process is performed according to the settings (e.g., reading resolution) made through the operation panel 13. In this push-scan process, the reading process by the reading engine 11 is performed to generate image data of the target object, the image data is encrypted, and the encrypted image data is transmitted from the MFP 2 to the PC 3.

On the other hand, if it is confirmed that encrypted communication implementation information is not included in the capability information, information on a port for the unencrypted communication is transmitted from the PC 3 to the MFP 2 for the unencrypted communication, and data communication is initiated between the PC 3 and the MFP 2 for performing the push-scan process. In the MFP 2, the push-scan process is performed according to the settings made through the operation panel 13. In this push-scan process, the reading process by the reading engine 11 is performed to generate image data of the target object, and the image data is transmitted from the MFP 2 to the PC 3 without being encrypted.

Alternatively or optionally, the MFP 2 may have a facsimile function, and the image processing system 1 may be configured to perform a PC facsimile, in which the PC 3 instructs the MFP 2 to perform a facsimile reception process as an example of the image processing.

In a configuration where the PC facsimile is performed, when the PC 3 is operated by the user and a command to start the PC facsimile is input to the PC 3, a request is transmitted (GetRequest) from the PC 3 to the MFP 2 designating the OID of the encrypted communication implementation information stored in the MIB 16. In response to the request, the MFP 2 transmits, to the PC 3, a response indicating the value of the OID designated by the PC 3 (GetResponse). When it is confirmed that the capability information stored in the MIB 16 contains the encrypted communication implementation information based on the value of the OID, information on a port for encrypted communication is transmitted from the PC 3 to the MFP 2 for the encrypted communication, and data communication is initiated between the PC 3 and the MFP 2 for the execution of the PC facsimile receiving process, which is an example of an image processing process. In this data communication, the image data received by the MFP 2 via the facsimile communication is encrypted, and the encrypted image data is transmitted from the MFP 2 to the PC 3.

On the other hand, if it is confirmed that the encrypted communication implementation information is not included in the capability information based on the value of the OID, information on a port for the unencrypted communication is transmitted from the PC 3 to the MFP 2 for the unencrypted communication, and the data communication between the PC 3 and the MFP 2 for performing the PC facsimile reception process is initiated. In this data communication, the image data received by the MFP 2 is transmitted from the MFP 2 to the PC 3 using the unencrypted communication.

The application layer protocol may be a proprietary protocol created by the manufacturer of the MFP 2.

Although the MFP 2 is addressed as an example of the image processing device, the image processing device may be a single function reading device with a reading function.

Various other design changes can be made to the aforementioned configurations within the scope of the claims.

In the above-described embodiment, a combination of the first communication and the second communication is discussed. However, aspects of the present disclosure can be applied to a combination of more than two communication methods.

What is claimed is:

1. An image processing system comprising:
an image processing device; and
a computer,
the image processing device and the computer being connectable to a network, the computer having capability of performing data communication in accordance with a first communication and in accordance with a second communication that is different from the first communication,
the image processing device being configured to perform data communication in accordance with at least the first communication,
wherein the image processing device comprises:
an image processing engine configured to perform image processing; and
a capability information repository configured to store capability information indicating capabilities of the image processing device, and
wherein the computer comprises a controller configured to perform:
retrieving the capability information stored in the capability information repository of the image processing device;
determining whether the capability information includes second communication implementation information indicating that the image processing device is capable of performing the second communication;
when the capability information includes the second communication implementation information, designating a port to perform the second communication and performing data communication for the image processing in accordance with the second communication; and
when the capability information does not include the second communication implementation information, not designating a port to perform the second communication.

2. The image processing system according to claim 1, wherein:
the first communication is an unencrypted communication; and
the second communication is an encrypted communication.

3. The image processing system according to claim 1,
wherein the capability information repository is a management information base, and
wherein the controller is configured to determine whether the capability information includes the second communication implementation information retrieved from the capability information repository in accordance with a simple network management protocol.

4. The image processing system according to claim 1,
wherein, when determining that the capability information does not include the second communication implementation information, the controller designates another port for the first communication to perform the data communication for the image processing in accordance with the first communication.

5. The image processing system according to claim 1,
wherein the image processing includes a process of transmitting image data from the image processing device to the computer.

6. The image processing system according to claim 5,
wherein the image processing engine includes a reading engine configured to read an object to be read and generates image data representing the object to be read, and
wherein the image processing includes a pull scan process of transmitting the image data generated by the reading engine from the image processing engine to the computer in response to an instruction from the computer.

7. A non-transitory computer-readable recording medium for a computer which is configured to be connected to an image processing device through a network, the image processing device having an image processing engine to perform image processing and a capability information repository storing capability information concerning capabilities of the image processing device, the recording medium storing computer-executable instructions that cause, when executed, the computer to perform:
retrieving the capability information stored in the capability information repository of the image processing device;
determining whether the capability information includes second communication implementation information indicating that the image processing device is capable of performing a second communication which is different from a first communication;
when the capability information includes the second communication implementation information, designating a port to perform the second communication and causing the image processing device to perform data communication for the image processing in accordance with the second communication, and
when the capability information does not include the second communication implementation information, not designating a port to perform the second communication.

8. The non-transitory computer-readable recording medium according to claim 7,
wherein the instructions cause, when executed, the computer to further perform:
a data communication to perform the image processing in accordance with the first communication by designating a port of the first communication when it is determined that the capability information does not include the second communication implementation information.

9. An image processing device, comprising:
a first communication port for a first communication to be implemented by a first program such that the image processing device is connectable to a computer through a network;
a second communication port for a second communication to be implemented by a second program such that the image processing device is connectable to the computer through the network, the second program being different from the first program;
an image processing engine configured to perform image processing; and
a capability information repository configured to store capability information concerning capabilities the image processing device has,
wherein the capability information contains second communication implementation information indicating that the image processing device has a capability of the second communication.
